(19) United States
(12) Patent Application Publication
(10) Pub. No.: US 2026/0029778 A1
(43) Pub. Date: Jan. 29, 2026

(54) METHOD FOR MACHINING WORKPIECES WITHIN A MACHINING MACHINE

(71) Applicant: Ponticon GmbH, Wiesbaden (DE)

(72) Inventors: Tobias STITTGEN, Ingelheim (DE); Thomas HORR, Bischofsheim (DE)

(73) Assignee: Ponticon GmbH, Wiesbaden (DE)

(21) Appl. No.: 18/998,382

(22) PCT Filed: May 23, 2023
(86) PCT No.: PCT/EP2023/063830

§ 371 Date: Apr. 24, 2025

(30) Foreign Application Priority Data
Jul. 26, 2022 (LU) LU502569

(51) Int. Cl. G05B 19/416; B23K 26/08; B23K 26/342; B33Y 10/00

(52) U.S. Cl. CPC G05B 19/416; B23K 26/0892; B23K 26/342; B33Y 10/00; G05B 2219/34175; G05B 2219/43009; G05B 2219/45138; G05B 2219/45164

(57) ABSTRACT

In a method for machining workpieces within a machining machine a tool is moved relative to a workpiece (1). The tool or the workpiece (1) travels at a predeterminable travel speed in a travel direction which is predetermined by a movement path (3). The movement path (3) is divided into machining portions (4) and acceleration portions (5). Within the machining portions (4), the workpiece is machined between a starting point (6) and an end point (7) of the machining portion (4) at a predeterminable machining travel speed in a machining travel direction. The travel speed is adjusted along the acceleration portion (5), which is defined by the end point (7) of a first machining portion (11) and the starting point (6) of a second machining portion (12), such that the predetermined machining travel speed is reached at the starting point (6) of the machining portion (4).

### CROSS-REFERENCE TO RELATED APPLICATION

This application is a national stage application, filed under 35 U.S.C. § 371, of PCT/EP2023/063830, filed on May 23, 2023, which claims the benefit of Luxembourg Patent Application LU502569, filed on Jul. 26, 2022.

### BACKGROUND

The disclosure relates to a method for workpiece machining within a machining machine, in which a tool is moved relative to a workpiece.

The generic term “machining machine” used here includes cutting machines, painting machines, milling machines and laser deposition welding machines. What all machining machines have in common is that they have an axis system with which either the tool or the workpiece is moved in order to realise the travel movement required for the machining process. In addition to the travel speed, other process-specific machining parameters are predetermined for the respective machining portion for workpiece machining. In laser deposition welding, for example, the laser power, a degree of defocussing of the laser beam, a distance to the workpiece or a powder mass flow are predetermined.

In machine control systems, the specified machining parameters can be predetermined at the starting point and at the end point of the machining portion, so that the machining parameters and/or the travel speed along the machining portion can be adjusted in a time-resolved or spatially resolved.

Due to the masses to be moved and the resulting inertial forces, the kinematics of the machining machines are often restricted in such a way that the maximum acceleration and thus the increase in speed along a defined portion of the movement path is limited by the machine-related maximum permissible jerk, so that the predetermined machining parameters are not reached at a starting point of the machining portion. For example, it may be the case that a machining speed predetermined at the starting point of the machining portion is undershot due to insufficient acceleration and the machining process is carried out with actual machining parameters that differ from the predetermined target machining parameters. The result is a machining process that is carried out under deviating process conditions, which can lead directly to a deviating machining result.

Furthermore, mass inertia-related path deviations can occur during the machining process at high machining speeds. This means that the predetermined movement path of the tool or workpiece is not maintained. This leads directly to a deviation from the target geometry or to a machining process that is carried out under deviating process conditions, which can lead directly to a deviating machining result.

Laser deposition welding is used in known embodiments for coating or repairing a workpiece or for the additive manufacturing of components. A powdery filler material, for example a metal powder, is introduced into the interaction zone of the laser radiation with the metal powder with the aid of a powder feed nozzle and is melted there by means of laser radiation, so that a bond is created between the molten metal powder and the workpiece or the layer that has already been applied.

In a variant of laser deposition welding, extreme high-speed laser deposition welding (EHLA for short (extreme high-speed laser application)), the powdered filler material is melted by the focussed laser beam before it enters the molten pool generated by the laser beam. This allows very high travel speeds in the range of 10 m/min to 500 m/min to be realised and layers with a thickness of 10 μm to 250 μm per layer to be produced.

The workpiece can be moved relative to the laser beam and the powder gas jet so that a melting track is created on the workpiece surface. Three-dimensional structures can be built additively by superimposing individual layers. Such structures are either built on existing components or, when creating entire objects, on a workpiece carrier plate, which then serves as the base.

In order to achieve such high machining travel speeds, high demands must be placed on the process technology and kinematics of the devices used. In particular, the usually large workpiece weights and the large masses of the tool, such as the powder nozzle or the laser optics, must be taken into account during the travel movement.

### SUMMARY

In a method for workpiece machining within a machining machine a tool is moved relative to a workpiece. The tool or the workpiece travels at a predeterminable travel speed in a travel direction predetermined by a movement path. The movement path is divided into machining portions and acceleration portions. Within the machining portions the workpiece is machined between a starting point and an end point of the machining portion at a predeterminable machining travel speed in a machining travel direction.

It is considered to be the object of the present disclosure to provide a process strategy for a machining process with which the machining of a workpiece can be carried out at a starting point of the machining path with predetermined machining parameters and at travel speeds of 10 m/min to 500 m/min.

This object is achieved by adjusting the travel speed along the acceleration portion defined by the end point of a first machining portion and the starting point of a second machining portion so that the predetermined machining travel speed is reached at the starting point of the machining portion.

With the relative speeds between the tool and the workpiece occurring in the EHLA process in the range of from 10 m/min to 200 m/min, preferably more than 500 m/min, and accelerations of more than 50 m/s², high pulses are generated by the moving masses. These pulses can influence the surroundings of the device and may lead to undesirable interference during the laser deposition welding process. By accelerating the tool or the workpiece along the acceleration path portions and thus outside the machining portion, the high pulses and accelerations that occur can be reduced, as an extended acceleration distance is available to achieve the predetermined machining speed. This means that the accelerations of the tool and the tool holder or accelerations of the workpiece can be set below the maximum permissible acceleration.

However, it is also provided that along the acceleration portion, in addition to an increase in the travel speed, a reduction in the travel speed is also provided. It is also provided that the travel speed along the acceleration portion is not changed at all and the travel movement of the workpiece or the tool along the acceleration path is performed at a constant speed.

In order to be able to set an increased machining travel speed between the tool and the workpiece, in an advantageous implementation, it is provided that both the tool and the workpiece are moved for the movement of the tool relative to the workpiece, wherein the tool and the workpiece are each moved in different travel directions or at different travel speeds. This allows the machining travel speed to be doubled.

In an advantageous embodiment, it is provided that the travel movement of the tool and/or the workpiece takes place in three spatial directions (x, y, z). The relative movement between the workpiece and the machining tool of the machining machine is decisive here. Depending on the configuration and type of the machining machine, a movement of the workpiece and/or a movement of the machining tool takes place. For this purpose, the movements are carried out in the three spatial directions (x, y, z), preferably path movements.

In an advantageous embodiment, it is provided that the acceleration portion is divided into a plurality of acceleration path portions, wherein the acceleration path portions can each be predetermined by a geometric shape and a length of the acceleration path portion. This enables a particularly flexible configuration of the acceleration portions. The geometric form of the acceleration portion can, for example, be a straight line, a segment of a circle with a specific radius, a portion of a hyperbola and so on.

In order to achieve the desired optimisation of workpiece machining, an advantageous embodiment of the method provides for the geometric shape and length of the acceleration path portions to be determined as a function of the machining speeds predetermined at the starting point and at the end point of the machining portion. This makes it possible to configure the acceleration path portions with the aim of constant travel speeds, constant acceleration, reduced path deviation in the process, reduced jerk or shortened machining time.

In an advantageous embodiment, it is provided that the acceleration portion extends in all three spatial directions, so that no plane exists in which the acceleration portion lies completely. It is advantageously provided that at least one acceleration path portion is arranged in an acceleration path plane which differs from a machining path plane comprising the starting point or the end point of the machining portion. The fact that travel movements of the tool and/or the workpiece are possible in the three spatial directions (x, y, z) means that the travel movement and travel speed can be flexibly configured along the acceleration path portions. This also makes it possible to keep the travel speed constant along the acceleration portions, as a geometric shape of the acceleration portions is selected so that the machine-related maximum permissible acceleration is not exceeded. Depending on the space available and limited by the workpiece or the tool, the three spatial directions (x, y, z) can also be optimally utilised by the configuration of the acceleration path portions.

Particularly in the case of large differences between the machining travel speed at an end point of a machining portion and the machining travel speed at a starting point of a subsequent machining portion, a large acceleration of the tool or the workpiece is necessary in order to be able to compensate for the difference in travel speed in order to achieve the predetermined machining travel speed at the starting point. An acceleration path portion can be arranged on the machining portion and have a geometric shape so that the travel speed along the acceleration portion can be achieved, for example, by constant acceleration of the tool or workpiece. This can be achieved, for example, by the geometric design as a circle with a large radius or by a hyperbolic portion, so that the machine-related maximum permissible acceleration can be undercut.

However, it is also conceivable to increase the travel speed along an acceleration portion and reduce the travel speed so that a reduced machining time is possible overall.

This means that it is not necessary to increase the travel speed to the machining travel speed of the starting point, or only to a small extent, so that a shorter machining time is possible.

In order to enable an acceleration-free passage over the starting point, an advantageous embodiment of the method provides that the acceleration path portion upstream of the starting point of the machining portion in the direction of travel is aligned in such a way that, viewed in the direction of travel, a transition angle enclosed by the acceleration path portion and the machining travel direction is a value of from 0 degrees to 1 degree at the starting point of the machining portion. For example, the upstream acceleration path portion can be arranged tangentially to the machining portion, wherein it is circular, elliptical or has a shape other than a straight line. It is particularly advantageous for the upstream acceleration path portion to be connected to the machining portion without offset, so that it is possible to pass over the starting point without acceleration and without sudden travel movements.

In order to enable particularly fast workpiece machining, an advantageous embodiment provides for workpiece machining within the machining portion to be carried out at a machining travel speed in the range of from 10 m/min to 500 m/min.

In an advantageous realisation, it is provided that the machining machine is designed in such a way that extreme high-speed deposition welding (EHLA) can be carried out with the machining machine.

For this purpose, the workpiece is moved in the three spatial directions (x, y, z) relative to a welding head arranged parallel to the workpiece carrier. In extreme high-speed deposition welding, a powder nozzle is used as a tool through which a powdery filler material is injected into the laser beam before the molten powder reaches the weld pool created on the workpiece surface. This produces very thin layers on the workpiece surface with layer thicknesses in the range of from 10 μm to 250 μm per layer.

A further advantageous embodiment is explained with reference to the exemplary embodiment shown in the drawings.

### BRIEF DESCRIPTION OF THE DRAWINGS

FIG. 1 shows a schematic representation of a predetermined movement path on a workpiece in a plan view of the workpiece, and

FIG. 2 shows a schematic representation of a movement path predetermined on the workpiece in a perspective view.

### DETAILED DESCRIPTION

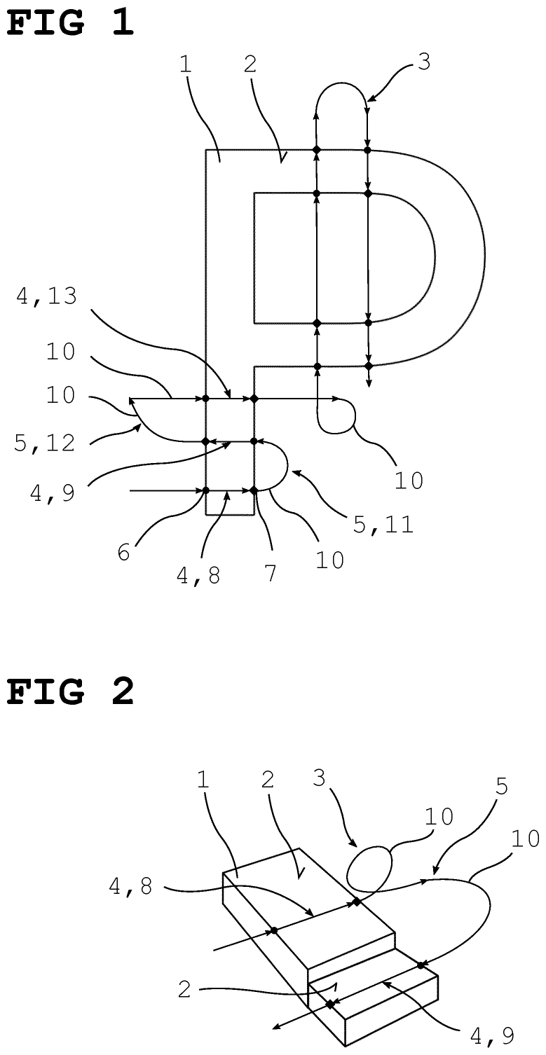

In FIG. 1, a workpiece 1 is shown in a schematic plan view. In addition, a movement path 3 is shown schematically on a workpiece surface 2 of the workpiece 1. A tool, which is not shown, is moved along the movement path 3 at a predeterminable travel speed in a travel direction predetermined by the movement path 3. The movement path 3 is divided into machining portions 4 and acceleration portions 5. The machining portions 4 are each defined by a starting point 6 and an end point 7, wherein workpiece machining is carried out in the machining portion 4 with the tool (not shown) at a machining travel speed. Along the acceleration portion 5 defined by the end point 7 of a first machining portion 8 and the starting point 6 of a second machining portion 9, the travel speed is adjusted so that the predetermined machining travel speed is reached at the starting point 6 of the machining portion 4. A first acceleration portion 11 is semi-circular in shape. A second acceleration portion 12 is divided into two acceleration path portions 10. The first acceleration path portion 10 is designed as a circular segment and the second acceleration path portion 10 is designed as a straight line. The second acceleration path portion 10, which precedes the starting point 6 of a third machining portion 13 in the direction of travel, is arranged without offset and without interruption to the third machining portion 13 in the direction of travel, so that the tool (not shown) is moved from the acceleration path portion 10 of the second acceleration portion 12 into the third machining portion 13 without abrupt travel movements.

In FIG. 2, the workpiece 1 is shown schematically in a perspective view. In addition, the movement path 3 shown schematically on the workpiece surfaces 2 of the workpiece 1 is shown. The tool, which is not shown, is moved along the movement path 3 at the predeterminable travel speed in the travel direction predetermined by the movement path 3. The movement path 3 shown in FIG. 2 is divided into the first machining portion 8, a second machining portion 9 and acceleration portions 5. The acceleration portion 5 is divided into two acceleration path portions 10. The second acceleration path portion 10 is arranged in an acceleration path plane that differs from a machining path plane comprising the starting point or the end point of the machining portion.

In the illustrations in FIG. 1 and FIG. 2, only individual elements of several similar elements are labelled with a reference sign by way of example.

1.-9. (canceled)

10. A method for machining workpieces within a machining machine, comprising:
moving a tool relative to a workpiece (1),
wherein the tool or the workpiece (1) travels at a predeterminable travel speed in a travel direction,
wherein the travel direction is predetermined by a movement path (3),
wherein the movement path (3) is divided into machining portions (4) and acceleration portions (5);
machining the workpiece within the machining portions (4) between a starting point (6) and an end point (7) of the machining portion (4) at a predeterminable machining travel speed in a machining travel direction; and
adjusting the travel speed along the acceleration portion (5),
wherein the acceleration portion (5) is defined by the end point (7) of a first machining portion (4) and the starting point (6) of a second machining portion (4), such that the predetermined machining travel speed is reached at the starting point (6) of the machining portion (4).

11. The method according to claim 10,
wherein moving the tool relative to the workpiece (1) comprises moving both the tool and the workpiece (1) and moving the tool and the workpiece (1) in different directions of travel or at different travel speeds.

12. The method according to claim 10,
wherein moving the tool and/or the workpiece (1) takes place in three spatial directions (x, y, z).

13. The method according to claim 10,
wherein the acceleration portion (5) is subdivided into a plurality of acceleration path portions (10),
wherein the acceleration path portions (10) are each predeterminable by a geometric shape and a length of the acceleration path portion (10).

14. The method according to claim 13,
wherein a geometric shape and a length of the acceleration path portions (10) are determined as a function of the machining travel speeds predetermined at the starting point (6) and at the end point (7) of the machining portion (4).

15. The method according to claim 10,
wherein the acceleration portion (4) extends in all three spatial directions, so that no plane exists in which the acceleration portion lies completely.

16. The method according to claim 13,
wherein the acceleration path portion (10) upstream of the starting point (6) of the machining portion (4) in the direction of travel is aligned such that, viewed in the direction of travel, a transition angle (17) enclosed by the acceleration path portion (10) and the machining travel direction is a value of from 0 degrees to 1 degree at the starting point (6) of the machining portion (4).

17. The method according to claim 10,
wherein the workpiece machining is carried out within the machining portion (4) at a machining travel speed in the range of from 10 m/min to 500 m/min.

18. The method according to claim 17,
wherein the machining machine is designed in such a way that extreme high-speed deposition welding (EHLA) can be carried out with the machining machine.
